(19) United States
(12) Patent Application Publication
(10) Pub. No.: US 2012/0037168 A1
(43) Pub. Date: Feb. 16, 2012

(54) Dental device for weight control

(76) Inventor: Terry L. Jackson, St. Louis, MO (US)

(21) Appl. No.: 12/806,567

(22) Filed: Aug. 16, 2010

(51) Int. Cl. A61C 5/14

(52) U.S. Cl. 128/861

(57) ABSTRACT

A dental device for weight control is disclosed which comprises a body having an upper side and a lower side, a protrusion extending from the lower side for extending into an oral cavity to reduce a volume of the oral cavity, a front edge positioned between the upper side and the lower side contoured to fit against teeth, and a back edge positioned between the upper side and the lower side, the back edge for bearing against a roof of a mouth.

### BACKGROUND

This disclosure relates generally to a dental device used to aid in weight reduction or weight control, and more particularly, to a dental device for reducing an amount of food that may be introduced into an oral cavity of an individual.

There is a substantial market for products which promise to make weight loss easier, quicker, and cheaper. Some known products include books, CDs, cremes, lotions, pills, diet foods, diet drinks, and body wraps. There are also weight loss services such as fitness centers, personal coaches, weight loss groups, and food products and supplements. Billions of dollars are spent each year on all types of diet programs and products. Although such products and services may be helpful for a limited period of time, individuals fall back into previous habits and the loss weight is gained back. It is also possible and common that more weight is gained than what was the original weight of the individual prior to weight loss. Further, there are various medical procedures that can be performed to remove fat from a person or to decrease the amount of food that an individual can consume such as stomach stapling. Some individuals are reluctant to have a medical procedure performed due to complications.

However, one of the most effective ways to reduce weight is to reduce the number of calories consumed each day. It is recommended that food be consumed slowly in order to feel filled up quicker. Being able to take smaller bites of food can lead to eating food slower. In view of this there is a need for a dental device that may be used to control weight by reducing a volume of an individual's oral cavity to slow down the rate of food consumption. It would also be advantageous to be able to provide a dental device that is comfortable to use and wear and does not obstruct or interfere with the use of a mouth. It would also be beneficial to provide a dental device that is self-supporting within a mouth, can be easily fitted within a mouth, and does not require any attachment devices for holding or securing the dental device within a mouth.

### SUMMARY

In one form of the present disclosure, a dental device for weight control is disclosed which comprises a body having an upper side and a lower side, a protrusion extending from the lower side for extending into an oral cavity to reduce a volume of the oral cavity, a front edge positioned between the upper side and the lower side contoured to fit against teeth, and a back edge positioned between the upper side and the lower side, the back edge for bearing against a roof of a mouth.

In another form of the present disclosure, a dental device for weight control comprises a a body having an upper side and a lower side, a protrusion extending from the lower side for extending into an oral cavity to reduce a volume of the oral cavity, a front edge positioned between the upper side and the lower side contoured to fit against teeth, a back edge positioned between the upper side and the lower side, the back edge for bearing against a roof of a mouth, and a catch extending from the lower side of the body.

In yet another form of the present disclosure, a dental device for weight control comprises a body having an interior side, an exterior side, a left side back portion, and a right side back portion and a teeth engaging surface positioned between the interior side and the exterior side with the teeth engaging surface having a soft cushioning surface.

In light of the foregoing comments, it will be recognized that a principal object of the present disclosure is to provide a dental device for weight control that decreases a volume of an oral cavity of a mouth to reduce an amount of food that may be introduced into an oral cavity.

A further object of the present disclosure is to provide a dental device for weight control which is of simple construction and design, is inexpensive, and which can be easily employed with highly reliable results.

Another object of the present disclosure is to provide a dental device for weight control that is easy to use, comfortable to wear, frictionally engages an interior of a mouth for retention within a mouth, may be easily removed from a mouth after use of the dental device, is comfortable to wear, and does not cause any injury to soft tissue within a mouth.

A still further object of the present disclosure is to provide a dental device for weight control that can be easily cleaned and stored when not in use.

A further object of the present disclosure is to provide a dental device weight control that does not require any metal structure such as retainer wires or ball clasps that can be broken, or fall off during use, or require replacement or realignment.

Another object of the present disclosure is to provide a dental device for weight control that may be fitted to a lower jaw to decrease a volume of an oral cavity to reduce an amount of food that may be inserted into an oral cavity of a mouth.

Yet another object of the present disclosure is to provide a dental device for weight control that may be easily manufactured and custom made based upon a mold of a mouth of an individual.

Still a further object of the present disclosure is to provide a dental device for weight control that is self-supporting when placed within a mouth and does not require any attachment devices for holding or securing the dental device in a mouth during use.

These and other objects and advantages of the present disclosure will become apparent after considering the following detailed specification in conjunction with the accompanying drawings, wherein:

### BRIEF DESCRIPTION OF THE DRAWINGS

FIG. 1 is a top perspective view of an embodiment of a dental device for weight control constructed according to the present disclosure;

FIG. 2 is a cross sectional view of the dental device for weight control constructed according to the present disclosure taken along the plane of line 2-2 in FIG. 1;

FIG. 3 is a cross sectional view of the dental device for weight control shown in phantom and shown inserted into an oral cavity of a mouth of an individual;

FIG. 4 is a top perspective view of another embodiment of a dental device for weight control constructed according to the present disclosure;

FIG. 5 is a partial cross section view of the dental device for weight control constructed according to the present disclosure taken along the plane of line 5-5 of FIG. 4; and

FIG. 6 is a partial cross section view of the dental device for weight control shown in phantom and shown inserted into an oral cavity of a mouth of an individual.

### DETAILED DESCRIPTION OF THE EMBODIMENTS

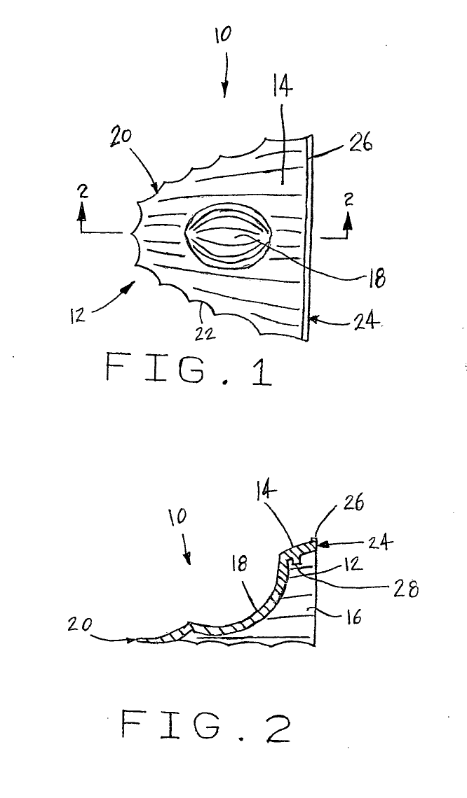

Referring now to the drawings, wherein like numbers refer to like items, number 10 identifies an embodiment of a dental device for weight control constructed according to the present disclosure. With reference now to FIGS. 1 and 2, the dental device 10 comprises a body 12 having an upper side or surface 14 and a lower side or surface 16. The body 12 also has a central portion or a protrusion 18 that extends from the lower side 16 and is adapted to extend into an oral cavity to reduce a volume of the oral cavity. The protrusion 18 is shown to be dome shaped or circular or oval in shape and may be centrally positioned on the body 12. However, it is possible and contemplated that the protrusion 18 may take on various other shapes that extend into the oral cavity and reduces the volume of the oral cavity. The body 12 has a front edge 20 that is shaped to fit against teeth and a roof of a mouth. The front edge 20 is positioned between the upper side 14 and the lower side 16. The front edge 20 includes a soft cushioning surface or material 22, such as an acrylic material, which provides a comfortable edging which bears against teeth, gums, or a roof of a mouth. The body 12 has a back edge 24 having a lip 26 that is adapted to bear against a palate or soft tissue within an oral cavity. The lip 26 can extend along the entire back edge 24 so as to seal the dental device 10 against a roof of a mouth. The back edge 24 is positioned between the upper side 14 and the lower side 16. A catch 28 is formed on the lower side 16 near the back edge 24 and opposite the lip 26. The catch 28 is provided for removal of the dental device 10 after use and serves as a lever to dislodge the dental device 10 from a roof of a mouth. The catch 28 may extend along a portion of the lower side 16. Although the catch 28 is shown extending out from the lower side 16, it is possible that the dental device 10 may be constructed without the catch 28 and the dental device 10 may be removed by grasping the back edge 24 and the lip 26.

The dental device 10 may be formed from any appropriate natural or synthetic material or materials, such as synthetic or natural rubber, medical rubber, plastics such as polyvinyl plastics material including vinyl acetate ethylene polymeric material, polyethylene vinyl acetate or a polyethylene or polypropylene. The material may be clear or colored. The dental device 10 may be custom made by taking a casting or a dental impression of an individual's mouth and teeth. From the casting the dental device 10 is produced which is adapted to fit in the interior of a mouth and have the upper teeth mate with or against the front edge 20 and the soft cushioning material 22. Also, the dental device 10 can be made of any lightweight material which is appropriate for use in the interior of the mouth 50, such as materials typically used for orthodontic type devices.

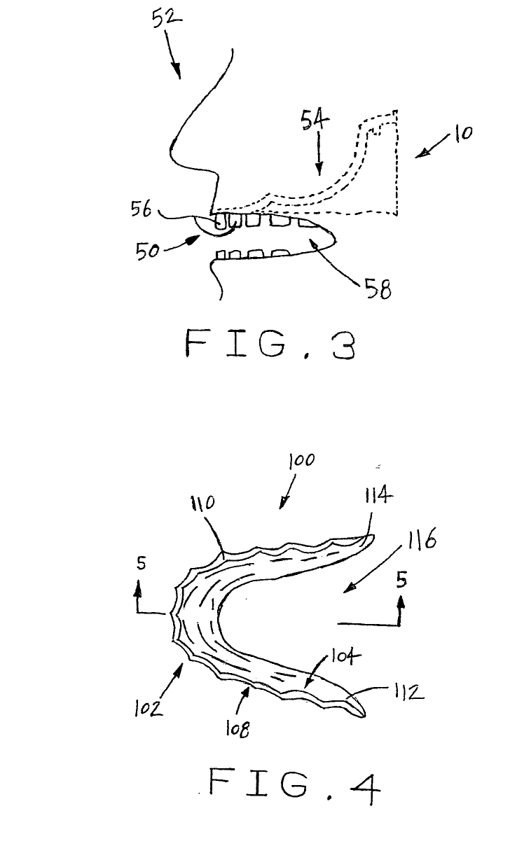

With reference now to FIG. 3, the dental device for weight control 10 is shown being inserted into a mouth 50 of an individual 52. The dental device 10 is placed against a roof or an upper palate 54 of the mouth 50. The front edge 20 is placed against upper teeth 56 of the mouth 50. The front edge 20 may mate with gums (not shown) associated with the teeth 56 or the upper palate 54. As has been discussed, the front edge 20 is sized and shaped to mate against the particular contours of the mouth 50 and the dental device 10 is custom made for the individual 52. A custom made dental device 10 can be made in a number of ways. One way is for the individual 52 to visit a dentist and have an impression made of the mouth 50. The impression may be sent to a manufacturer of the dental device 10. Once manufactured, the dental device 10 is sent to the dentist and the dentist fits the dental device 10 to the mouth 50 of the individual 52. A second, quicker, and less expensive method, is for the individual 52 to contact a manufacturer and have the manufacturer send the individual 52 a prepared dental impression kit having appropriate instructions. The individual 52 then makes their own dental impression using the kit and sends the impression to the manufacturer. Once the manufacturer completes the custom made dental device 10, the dental device 10 is sent to the individual 52 for use.

In operation, the dental device 10 is inserted into the mouth 50 of the individual 52. The catch 28 may be used to maneuver the dental device 10 into position against the roof 54 of the mouth 50 and abut the front edge 20 against the teeth 56. With the front edge 20 mating with or contacting the teeth 56 and the back edge 24 resting against the roof 54, this reduces the possibility of any food becoming lodged between the roof 54 and the upper side 14 of the dental device 10. Also, when the dental device 10 is inserted in the mouth 50 in this orientation suction develops between the device 10, the teeth 56, and the roof 54 to hold or seal the device 10 in place in the mouth 50. A volume associated with an oral cavity 58 of the mouth 50 is decreased so that an amount of food that can be introduced into the oral cavity 58 is decreased. The protrusion 18 extending into the oral cavity 58 decreases the size or volume of the oral cavity 58. The size of the protrusion 18 is dependent upon the size and shape of the dental impression of the mouth 50. Further, the size and shape of the protrusion 18 may be increased to further decrease the size of the oral cavity 58 in severe cases in which food intake is to be reduced in an extreme manner. Once the dental device 10 has been inserted into the mouth 50, the individual 52 can eat, drink, speak, and breath in a normal manner. The dental device 10 also has the impact of slowing down the individual's 52 rate of food consumption. By slowing down the rate of food intake and requiring food to be more thoroughly chewed before swallowing leads to reducing food intake and promotes weight loss. After use, the dental device 10 may be easily removed from the mouth 50 by grasping the catch 28, to reduce or overcome any suction created by having the dental device 10 pressed against the roof 54 and the teeth 56, and pulling the dental device 10 downwardly to remove the dental device 10 from the mouth 50. Once removed, the dental device 10 may be cleaned and stored for the next use.

The dental device 10 has a number of advantages. The dental device 10 is easy to place in the mouth 50 and remove from the mouth 50 due to the catch 28. Further, since there are no wires or ball clasps, the dental device 10 does not require adjustment to properly position and hold the dental device 10 in the mouth 50. Since the dental device 10 is a single piece construction, there are no pieces that can break off and be inadvertently swallowed. Further, wires or ball clasps can become out of alignment which would require realignment, adjustment, or a completely new dental device being manufactured. Due to the small size of the dental device 10, the dental device 10 may be keep in a small container so that the dental device 10 can be used at home, at the office, or at a restaurant. Further, since the dental device 10 is unobtrusive when in the mouth 50 it is not noticeable by others and the dental device 10 can be worn at all times. As has been discussed, the dental device 10 does not interfere with speech and the dental device 10 can be worn during the daytime.

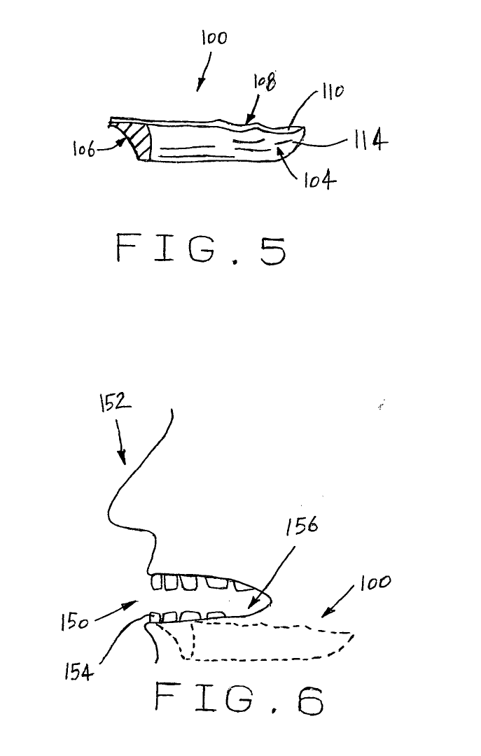

FIGS. 4 and 5 depict another embodiment of a dental device for weight control 100 constructed according to the present disclosure. The dental device 100 comprises a body 102 having a generally U-shape. The body 102 has an interior side or surface 104 and an exterior side or surface 106. The interior side 104 and the exterior side 106 intersect to form a teeth engaging surface 108. The teeth engaging surface 108 has a soft cushioning surface or material 110, such as an acrylic material, which provides a comfortable edging or surface which bears against lower teeth (not shown). The teeth engaging surface 108 has a generally scallop shape which is similar to the outline of lower teeth against which the surface 108 is adapted to mate or abut. The body 102 also has a left side back portion 112 and a right side back portion 114. With the body 102 being U-shaped there is an area or void 116 in which a tongue of an individual may be positioned in order for a tongue to move freely or be unobstructed during use of the dental device 100. Although not shown, it is also possible and contemplated that the dental device 100 may include one or more protrusions associated with the interior side 104 to increase the volume of the dental device 100.

Referring now to FIG. 6 the dental device for weight control 100 is shown being inserted into a mouth 150 of an individual 152. The dental device 100 is placed against backside surfaces or lingual surfaces of lower teeth 154 of the individual 152. The soft cushioning surface 110 of the teeth engaging surface 108 is placed against lower teeth 154 of the mouth 150. The teeth engaging surface 108 may also contact or mate with gums (not shown) associated with the lower teeth 154. The teeth engaging surface 108 is sized and shaped to mate against the particular contours of the mouth 150 and the dental device 100 is custom made for the individual 152. A custom made dental device 100 can be made in a number of ways, as has been identified with respect to the dental device 10.

The typical operation of the dental device 100 is as follows. The individual 152 inserts the dental device 100 into the mouth 150 and places the teeth engaging surface 108 against the lower teeth 154. The left side back portion 112 and the right side back portion 114 may be grasped by the individual 152 to guide or maneuver the dental device 100 into the mouth 150. With the teeth engaging surface 108 mating with or contacting the teeth 154 and the back portions 112 and 114 resting within the mouth 150, the chance of any food becoming trapped underneath the dental device 100 is reduced. In this manner, a volume associated with an oral cavity 156 of the mouth 150 is decreased so that an amount of food that can be introduced into the oral cavity 156 is decreased. The size of the dental device 100 is dependent upon the size and shape of the dental impression of the mouth 150. Further, the size and shape of the dental device 100 may be increased to further decrease the size of the oral cavity 156 in severe cases in which food intake is to be reduced in an extreme manner. Once the dental device 100 has been inserted into the mouth 150, the individual 152 can eat, drink, speak, and breath in a normal manner. Further, due to the void 116 of the dental device 100, a tongue (not shown) is free to move within the mouth 150. The dental device 100 has the impact of slowing down the individual's 152 rate of food consumption. Slowing down the rate of food intake and requiring food to be more thoroughly chewed before swallowing leads to the reduction of food intake and promotes weight loss. After use, the dental device 100 may be easily removed from the mouth 150 by grasping the back portions 112 and 114, to overcome any suction developed by having the dental device 100 positioned against the teeth 154, and pulling the dental device 100 upwardly to remove the dental device 100 from the mouth 150. Once removed, the dental device 100 may be cleaned and stored until the next application.

As can be appreciated, the dental device 100 may be formed from any appropriate natural or synthetic material or materials, such as synthetic or natural rubber, medical rubber, plastics such as polyvinyl plastics material including vinyl acetate ethylene polymeric material, polyethylene vinyl acetate or a polyethylene or polypropylene. The material may be clear or colored. The dental device 100 may be custom made by taking a casting or a dental impression of an individual's mouth, and in particular an impression of the lower teeth. From the casting the dental device 100 is produced which is adapted to fit against the lower teeth. 154. Also, the dental device 100 can be made of any lightweight material which is appropriate for use in the interior of the mouth 150, such as materials typically used for orthodontic type devices.

Furthermore, with use of the dental devices 10 and 100, smaller amounts of food will be consumed with each bite. By increasing the volume of the mouth 50 or 150, the individual 52 or 152 will require a longer period of time to eat food and may be satisfied with less food being consumed. By reducing food intake, the individual 50 or 150 will either have reduced weight or controlled weight. It is possible that over time the individual's stomach may shrink and weight loss will occur. By use of the dental devices 10 and 100, the individual 50 or 150 will easily and quickly develop a habit of eating less due to a reduced amount of food being consumed. This habit will lead to weight reduction and it is possible that the dental devices 10 and 100 after some period of time may be discontinued. Also, the dental devices 10 and 100 require no special training for their use and once inserted into the mouth 50 or 150 the dental devices 10 and 100 operated immediately and sufficiently.

As previously discussed, the dental devices 10 and 100 may take on any desired shape dependent upon the particular mouth in which the devices 10 and 100 are to be inserted and used. It should be recognized that the dental devices 10 and 100 are formed of relatively lightweight material so that the dental devices 10 and 100 can be quickly and easily manufactured, assembled, transported, and stored. Further, the dental devices 10 and 100 can be constructed of relatively inexpensive materials that will provide for the dental devices 10 and 100 to be mass produced, disposable, and suitable for long time use.

From all that has been said, it will be clear that there has thus been shown and described herein a dental device for weight control which fulfills the various objects and advantages sought therefor. It will become apparent to those skilled in the art, however, that many changes, modifications, variations, and other uses and applications of the subject dental device for weight control are possible and contemplated. All changes, modifications, variations, and other uses and applications which do not depart from the spirit and scope of the present disclosure are deemed to be covered by the present disclosure, which is limited only by the claims which follow.

1. A dental device for weight control comprising:
a body having an upper side and a lower side;
a protrusion extending from the lower side for extending into an oral cavity to reduce a volume of the oral cavity;
a front edge positioned between the upper side and the lower side contoured to fit against teeth;
a back edge positioned between the upper side and the lower side, the back edge for bearing against a roof of a mouth and
a catch extending from the lower side into the oral cavity and positioned offset from the back edge.

2. The dental device of claim 1 wherein the front edge mates with upper teeth.

3. The dental device of claim 1 wherein the back edge mates against a roof of a mouth.

4. The dental device of claim 1 wherein the front edge comprises a soft cushioning surface.

5. The dental device of claim 4 wherein the soft cushioning surface comprises an acrylic material.

6. The dental device of claim 1 wherein the back edge further comprises a lip extending from the upper side.

7. The dental device of claim 1 wherein the protrusion is circular in shape.

8. The dental device of claim 1 wherein the protrusion is centrally positioned on the body.

9. The dental device of claim 1 wherein the protrusion is oval in shape.

10. A dental device for weight control comprising:
a body having an upper side and a lower side;
a protrusion extending from the lower side for extending into an oral cavity to reduce a volume of the oral cavity;
a front edge positioned between the upper side and the lower side contoured to fit against teeth;
a back edge positioned between the upper side and the lower side, the back edge for bearing against a roof of a mouth; and
a catch extending from the lower side of the body into the oral cavity and positioned near the back edge.

11. The dental device of claim 10 wherein the front edge mates with upper teeth.

12. The dental device of claim 10 wherein the back edge mates against a roof of a mouth.

13. The dental device of claim 10 wherein the front edge comprises a soft cushioning surface.

14. The dental device of claim 13 wherein the soft cushioning surface comprises an acrylic material.

15. The dental device of claim 10 wherein the back edge further comprises a lip extending from the upper side.

16. A denial device for weight control comprising:
a body having an interior side, an exterior side, a left side back portion, and a right side back portion; and
a teeth engaging surface positioned between the interior side and the exterior side with the teeth engaging surface having a soft cushioning surface.

17. The dental device of claim 16 wherein the body has a generally U shape.

18. The dental device of claim 16 wherein the soft cushioning surface is comprises of an acrylic material.

19. The dental device of claim 16 wherein the teeth engaging surface is adapted to engage lower teeth.

20. The dental device of claim 16 wherein the exterior surface is adapted to be adjacent to an interior of a mouth.
